(19) United States
(12) Patent Application Publication
(10) Pub. No.: US 2009/0063514 A1
(43) Pub. Date: Mar. 5, 2009

(54) SYSTEM AND METHOD FOR GENERATING FILES HAVING CATEGORIZATION ARCHITECTURES FOR DIGITAL IMAGES

(75) Inventor: Steven R. J. Murphy, Scarborough (CA)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/847,884

(22) Filed: Aug. 30, 2007

(51) Int. Cl. G06F 7/00

(52) U.S. Cl. 707/100

(57) ABSTRACT

A system and a method for generating files having categorization architectures for digital images are provided. The method includes selecting primary category identifiers identifying distinct high-level types of digital images utilizing either a graphical user interface or an editor. The method further includes selecting subcategory identifiers associated with the primary category identifiers. The method further includes storing files having the primary category identifiers, the subcategory identifiers, and digital images associated therewith.

### FIELD OF INVENTION

This application relates to a system and a method for generating files having categorization architectures for digital images.

### BACKGROUND OF INVENTION

The number of digital images generated by people have increased dramatically over the last several years. However, it is often difficult for individuals to perform searches for digital images on computer systems, since the digital images generally do not have search identifiers associated therewith.

Accordingly, the inventor herein has recognized the need for a system and a method for generating files having categorization architectures for digital images.

### SUMMARY OF INVENTION

A method for generating files having categorization architectures for digital images in accordance with an exemplary embodiment is provided. The method includes selecting at least first, second, and third primary category identifiers identifying distinct high-level types of digital images utilizing either a graphical user interface “GUI” or an editor. The first, second, and third primary category identifiers are associated with first, second, and third digital images, respectively. The method further includes selecting a first subcategory identifier associated with the first primary category utilizing either the GUI or the editor. The first subcategory identifier identifies a first distinct type of digital image. The method further includes selecting a second subcategory identifier associated with the second primary category utilizing either the GUI or the editor. The second subcategory identifier identifies a second distinct type of digital image. The method further includes selecting a third subcategory identifier associated with the third primary category utilizing either the GUI or the editor. The second subcategory identifier identifies a third distinct type of digital image. The method further includes storing the first primary category identifier, the first subcategory identifier, and the first digital image in a first file. The method further includes storing the second primary category identifier, the second subcategory identifier, and the second digital image in a second file. The method further includes storing the third primary category identifier, the third subcategory identifier, and the third digital image in a third file.

A system for generating files having categorization architectures for digital images in accordance with another exemplary embodiment is provided. The system includes a memory device and a computer operably coupled to the memory device. The computer is configured to allow a user to select at least first, second, and third primary category identifiers identifying distinct high-level types of digital images utilizing either a GUI or an editor. The first, second, and third primary category identifiers are associated with first, second, and third digital images. The computer is further configured to allow the user to select a first subcategory identifier associated with the first primary category utilizing either the GUI or the editor. The first subcategory identifier identifies a first distinct type of digital image. The computer is further configured to allow the user to select a second subcategory identifier associated with the second primary category utilizing either the GUI or the editor. The second subcategory identifier identifies a second distinct type of digital image. The computer is further configured to allow the user to select a third subcategory identifier associated with the third primary category utilizing either the GUI or the editor. The second subcategory identifier identifies a third distinct type of digital image. The computer is further configured to store the first primary category identifier, the first subcategory identifier, and the first digital image in a first file. The computer is further configured to store the second primary category identifier, the second subcategory identifier, and the second digital image in a second file. The computer is further configured to store the third primary category identifier, the third subcategory identifier, and the third digital image in a third file.

### BRIEF DESCRIPTION OF DRAWINGS

FIG. 1 is a block diagram of a system for generating files having categorization architectures for digital images in accordance with an exemplary embodiment;

FIG. 2 is a schematic of an exemplary categorization architecture for digital images;

FIG. 3 is a schematic of a file having an exemplary categorization architecture for a digital image;

FIG. 4 is a schematic of an exemplary digital image;

FIG. 5 is a schematic of another file having an exemplary categorization architecture for a digital image;

FIG. 6 is a schematic of another file having an exemplary categorization architecture for a digital image;

FIG. 7 is a schematic of an exemplary GUI utilized to generate files having categorization architectures; and

FIG. 8 is a flowchart of a method for generating files having categorization architectures for digital images in accordance with another exemplary embodiment.

### DESCRIPTION OF EMBODIMENTS

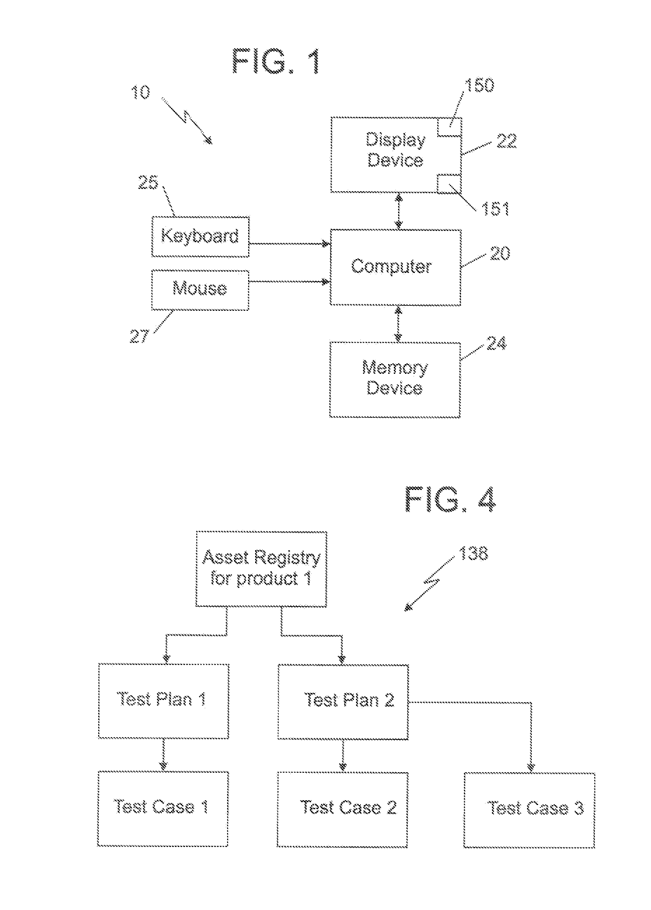

Referring to FIG. 1, a system 10 for generating files having categorization architectures for digital images is provided. The system 10 includes a computer 20, a display device 22, a memory device 24, a keyboard 25, and a mouse 27.

The computer 20 is provided to allow users to generate files having categorization architectures for digital images. The computer 20 is operably coupled to the display device 22, the memory device 24, the keyboard 25, and the mouse 27. In particular, the computer 20 is configured to induce the display device 22 to display either a GUI 150 or an editor 151 for allowing a user to input information utilizing the keyboard 25 and/or the mouse 27 to generate files having categorization architectures for digital images. The operation of the computer 20 will be explained in further detail below.

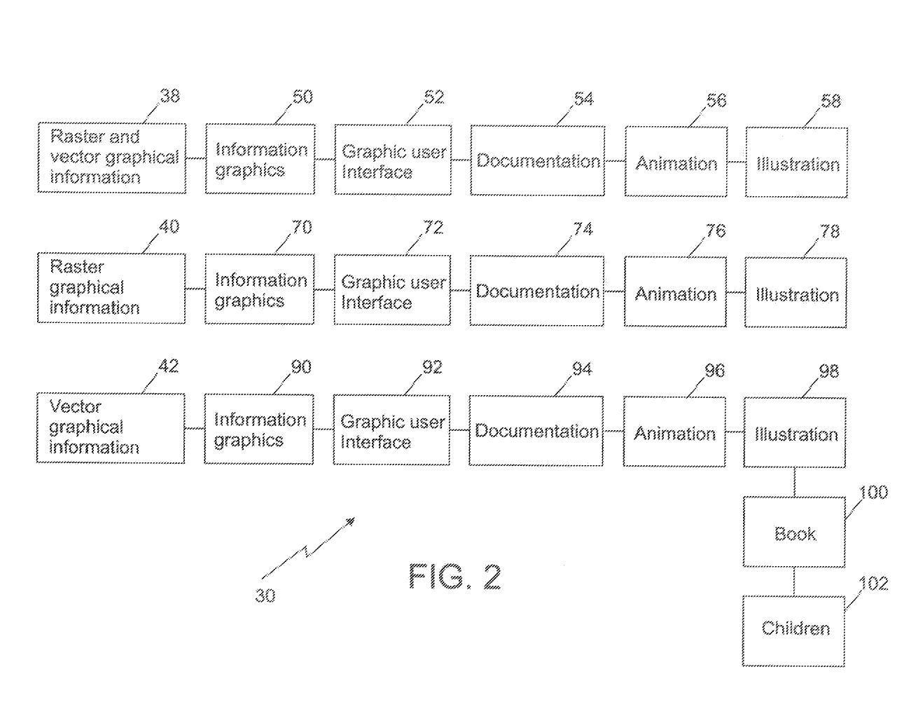

Referring to FIG. 2, an exemplary categorization architecture 30 is illustrated. The categorization architecture 30 includes three primary category identifiers for identifying three primary types of digital images. In particular, the three primary category identifiers are: (i) a raster and vector graphical information identifier 38, (ii) a raster graphical information identifier 40, and (iii) a vector graphical information identifier 42. The raster and vector graphical information identifier 38 identifies an associated digital image as a raster and vector graphical digital image. The raster graphical information identifier identifies an associated digital image as a raster digital image. The vector graphical information identifier 42 identifies an associated digital image as a vector digital image.

The raster and vector graphical information identifier 38 has a plurality of subcategory identifiers associated therewith. In particular, these subcategory identifiers associated with the raster and vector graphical information identifier 38 include for example an information graphics identifier 50, a graphic user interface identifier 52, a documentation identifier 54, an animation identifier 56, and an illustration identifier 58. The information graphics identifier 50 identifies an associated digital image as information graphics. The graphic user interface identifier 52 identifies an associated digital image as a graphical user interface. The documentation identifier 54 identifies an associated digital image as documentation. The animation identifier 56 identifies an associated digital image as an animation. The illustration identifier 58 identifies an associated digital image as an illustration.

The raster graphical information identifier 40 has a plurality of subcategory identifiers associated therewith. In particular, the subcategory identifiers associated with the raster graphical information identifier 40 include for example an information graphics identifier 70, a graphic user interface identifier 72, a documentation identifier 74 an animation identifier 76 and an illustration identifier 78. The information graphics identifier 70 identifies an associated digital image as information graphics. The graphic user interface identifier 72 identifies an associated digital image as a graphical user interface. The documentation identifier 74 identifies an associated digital image as documentation. The animation identifier 76 identifies an associated digital image as an animation. The illustration identifier 78 identifies an associated digital image as an illustration.

The vector graphical information identifier 42 has a plurality of subcategory identifiers associated therewith. In particular, these subcategory identifiers associated with the vector graphical information identifier 42 include for example an information graphics identifier 90, a graphic user interface identifier 92, a documentation identifier 94 an animation identifier 96 and an illustration identifier 98. The information graphics identifier 90 identifies an associated digital image as information graphics. The graphic user interface identifier 92 identifies an associated digital image as a graphical user interface. The documentation identifier 94 identifies an associated digital image as documentation. The animation identifier 96 identifies an associated digital image as an animation. The illustration identifier 98 identifies an associate digital image as an illustration. Further, the illustration identifier 98 has a book identifier 100 associated therewith. Still further, the book identifier 100 has a children identifier 102 associated therewith.

Accordingly, a type of digital image can be described utilizing the categorization architecture 30 described above. For example, utilizing identifiers 42, 98, 100 and 102, a digital image can be described as vector graphical information, wherein the vector graphical information comprises an illustration, wherein the illustration comprises a book, and the book corresponds to a children's book.

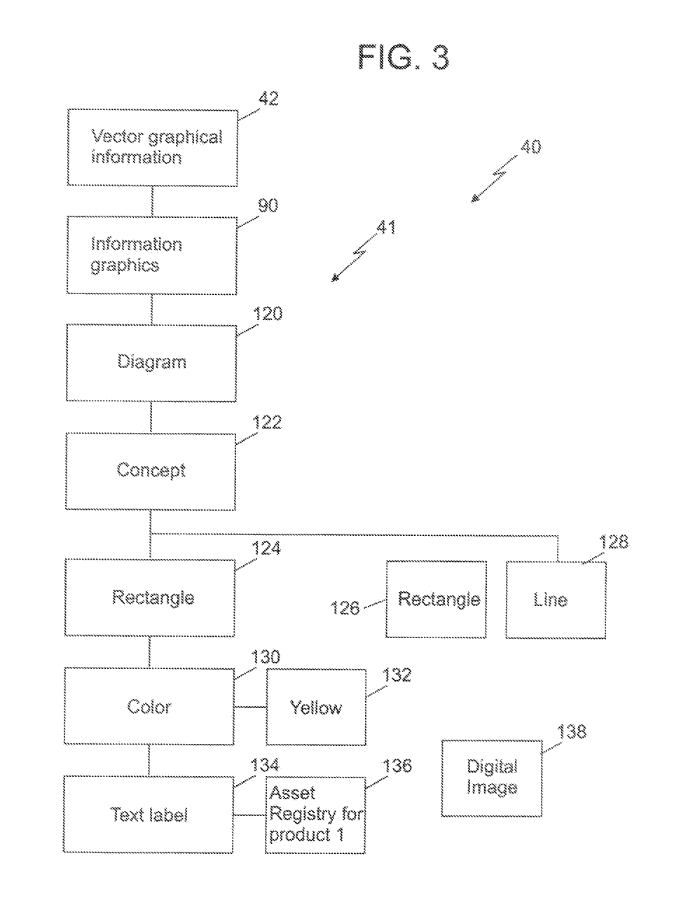

Referring to FIGS. 3 and 4, a file 40 having a categorization architecture 41 and a digital image 138 associated with the categorization architecture 41 is illustrated. The categorization architecture 41 includes a vector graphical information identifier 42, an information graphics identifier 90, a diagram identifier 120, a concept identifier 122, a rectangle identifier 124, a rectangle identifier 126, and a line identifier 128. The rectangle identifier 124 includes the following subcategory identifiers: a color identifier 130 having an associated yellow identifier 132. The color identifier 130 includes the following subcategory identifiers: a text label identifier 134 having an associated asset registry for product 1 identifier 136. The file 40 is stored in the memory device 24.

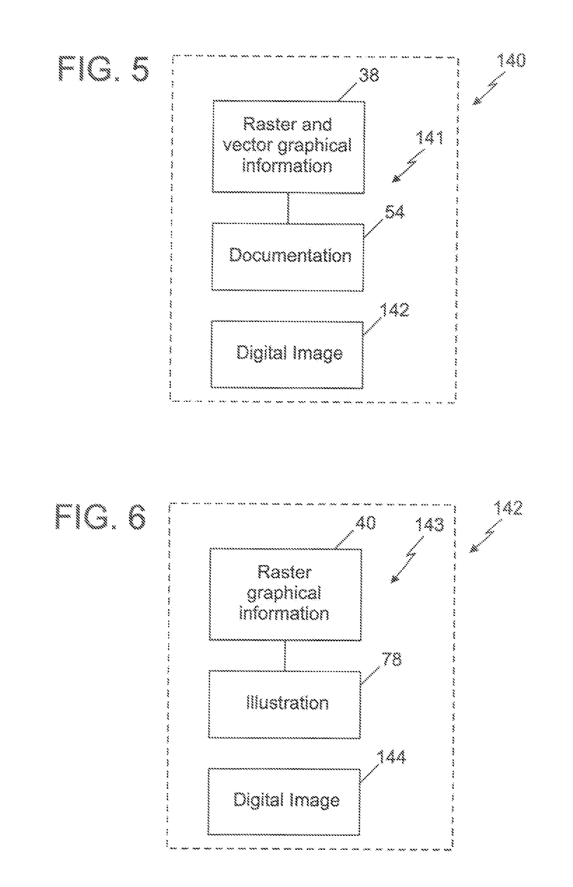

Referring to FIG. 5, a file 140 having a categorization architecture 141 and a digital image 142 associated with the categorization architecture 141 is illustrated. The categorization architecture 41 includes the raster and vector graphical information identifier 38, and a documentation identifier 54. The file 140 is stored in the memory device 24.

Referring to FIG. 6, a file 142 having a categorization architecture 143 and a digital image 144 associated with the categorization architecture 41 is illustrated. The categorization architecture 143 includes the raster graphical information identifier 40 and an illustration identifier 78. The file 142 is stored in the memory device 24.

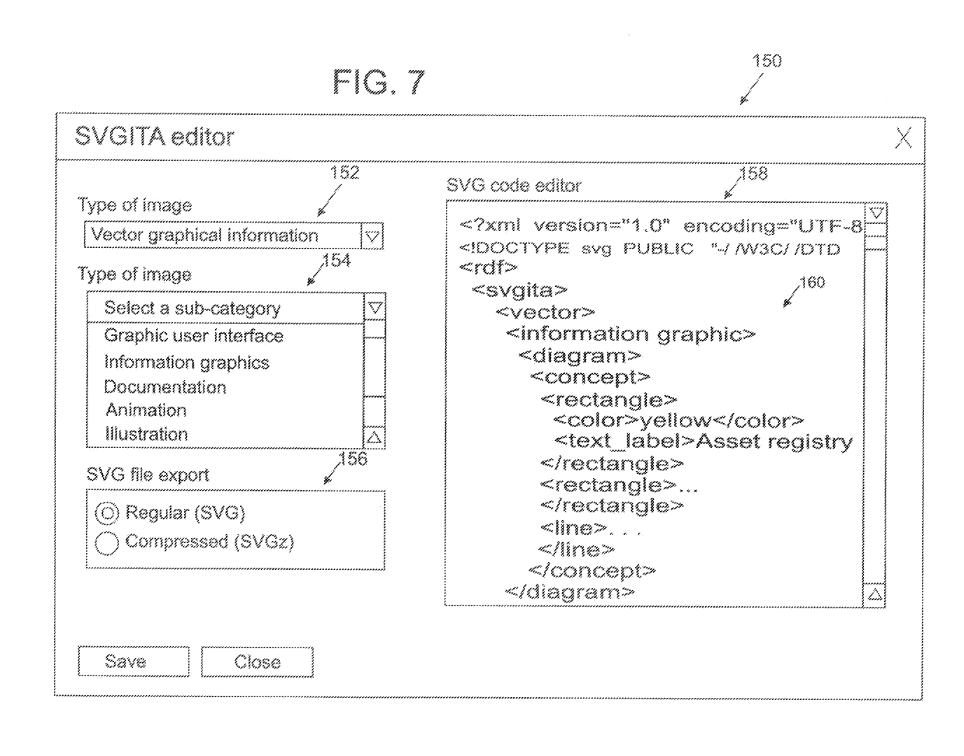

Referring to FIG. 7, a GUI 150 that can be generated by the computer 20 and displayed on the display device 22 is illustrated. The GUI 150 includes a selection menu 152 allows the user to select a primary category identifier. The GUI 150 further includes a selection menu 154 that allows the user to select subcategory identifiers. The GUI 150 further includes a selection menu 156 that allows the user to select the type of file in which to store the digital image and categorization architecture. For example, the user can select an SVG file or a compressed SVG file. The GUI 150 further includes a code editor window 158 that allows the user to select primary category identifiers and subcategory identifiers.

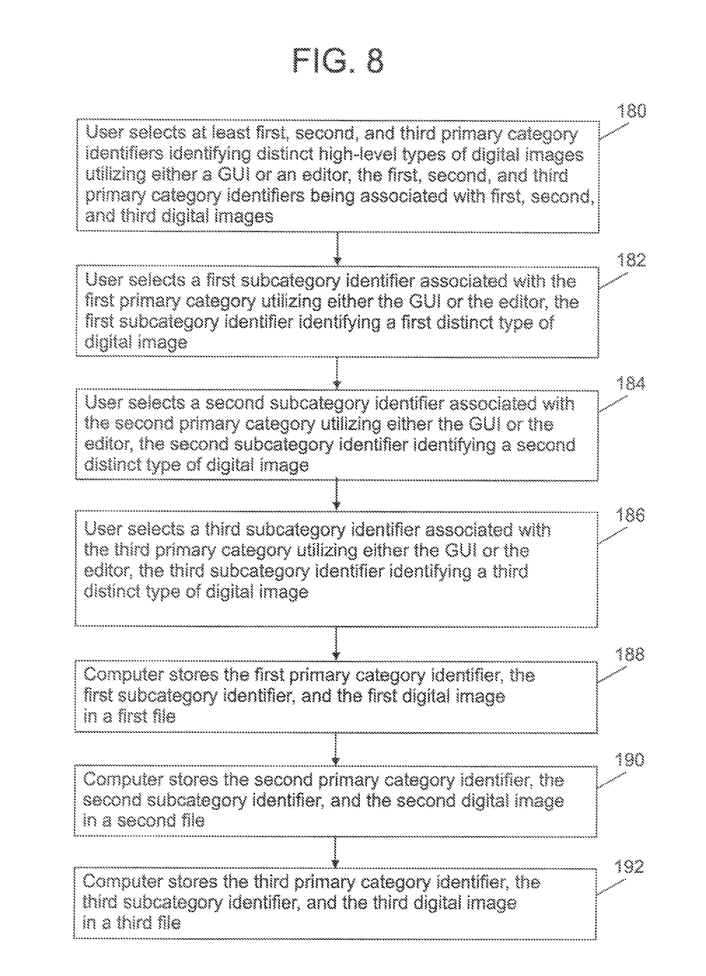

Referring to FIG. 8, the computer 20 is further configured to generate an editor 151 on the display device 150 which allows a user to specify primary category that fires and subcategory identifiers. Thus, the user can either use the editor 151 or the GUI 152 to define a categorization architecture for digital images.

Referring to FIG. 8, a flowchart of a method for generating files having categorization architectures for digital images will now be described.

At step 180, a user selects at least first, second, and third primary category identifiers identifying distinct high-level types of digital images utilizing either the GUI 150 or the editor 151. The first, second, and third primary category identifiers are associated with first, second, and third digital images.

At step 182, the user selects a first subcategory identifier associated with the first primary category utilizing either the GUI 150 or the editor 151. The first subcategory identifier identifies a first distinct type of digital image.

At step 184, the user selects a second subcategory identifier associated with the second primary category utilizing either the GUI 150 or the editor 151. The second subcategory identifier identifies a second distinct type of digital image.

At step 186, the user selects a third subcategory identifier associated with the third primary category utilizing either the GUI 150 or the editor 151. The second subcategory identifier identifies a third distinct type of digital image.

At step 188, the computer 20 stores the first primary category identifier, the first subcategory identifier, and the first digital image in a first file in the memory device 24.

At step 190, the computer 20 stores the second primary category identifier, the second subcategory identifier, and the second digital image in a second file in the memory device 24.

At step 192, the computer 20 stores the third primary category identifier, the third subcategory identifier, and the third digital image in a third file in the memory device 24.

The system and the method for generating files having categorization architectures for digital images provide a substantial advantage over other systems and methods. In particular, the system and the method provide a technical effect of generating files having categorization architectures that describes types of digital images.

While the invention is described with reference to an exemplary embodiment, it will be understood by those skilled in the art that various changes may be made and equivalence may be substituted for elements thereof without departing from the scope of the invention. In addition, many modifications may be made to the teachings of the invention to adapt to a particular situation without departing from the scope thereof. Therefore, it is intended that the invention not be limited the embodiment disclosed for carrying out this invention, but that the invention includes all embodiments falling with the scope of the intended claims. Moreover, the use of the term's first, second, etc. does not denote any order of importance, but rather the term's first, second, etc. are used to distinguish one element from another.

What is claimed is:

1. A method for generating files having categorization architectures for digital images, comprising:
selecting at least first, second, and third primary category identifiers identifying distinct high-level types of digital images utilizing either a GUI or an editor, the first, second, and third primary category identifiers being associated with first, second, and third digital images, respectively;
selecting a first subcategory identifier associated with the first primary category utilizing either the GUI or the editor, the first subcategory identifier identifying a first distinct type of digital image;
selecting a second subcategory identifier associated with the second primary category utilizing either the GUI or the editor, the second subcategory identifier identifying a second distinct type of digital image;
selecting a third subcategory identifier associated with the third primary category utilizing either the GUI or the editor, the second subcategory identifier identifying a third distinct type of digital image;
storing the first primary category identifier, the first subcategory identifier, and the first digital image in a first file;
storing the second primary category identifier, the second subcategory identifier, and the second digital image in a second file; and
storing the third primary category identifier, the third subcategory identifier, and the third digital image in a third file.

2. The method of claim 1, wherein the first primary category identifier corresponds to raster and vector graphical information.

3. The method of claim 2, wherein the second primary category identifier corresponds to raster graphical information.

4. The method of claim 3, wherein the third primary category identifier corresponds to vector graphical information.

5. The method of claim 1, wherein the first subcategory identifier comprises at least one of an information graphic identifier, a graphic user interface identifier, a documentation identifier, an animation identifier, and an illustration identifier.

6. A system for generating files having categorization architectures for digital images, comprising:
a memory device; and
a computer operably coupled to the memory device, the computer configured to allow a user to select at least first, second, and third primary category identifiers identifying distinct high-level types of digital images utilizing either a GUI or an editor, the first, second, and third primary category identifiers being associated with first, second, and third digital images, respectively;
the computer further configured to allow the user to select a first subcategory identifier associated with the first primary category utilizing either the GUI or the editor, the first subcategory identifier identifying a first distinct type of digital image;
the computer further configured to allow the user to select a second subcategory identifier associated with the second primary category utilizing either the GUI or the editor, the second subcategory identifier identifying a second distinct type of digital image;
the computer further configured to allow the user to select a third subcategory identifier associated with the third primary category utilizing either the GUI or the editor, the second subcategory identifier identifying a third distinct type of digital image;
the computer further configured to store the first primary category identifier, the first subcategory identifier, and the first digital image in a first file;
the computer further configured to store the second primary category identifier, the second subcategory identifier, and the second digital image in a second file; and
the computer further configured to store the third primary category identifier, the third subcategory identifier, and the third digital image in a third file.
